(19) United States
(12) Patent Application Publication
(10) Pub. No.: US 2010/0028609 A1
(43) Pub. Date: Feb. 4, 2010

(54) Resin molded article and method of manufacturing resin molded article

(75) Inventors: Kan'ichi Sato, Osaka (JP); Tamio Furuya, Gunma (JP); Satofumi Yamamori, Osaka (JP)

Correspondence Address: EVEREST INTELLECTUAL PROPERTY LAW GROUP, P. O. BOX 708, NORTHBROOK, IL, 60065, US

(73) Assignee: KOMATSU LTD.

(21) Appl. No.: 11/664,774

(22) PCT Filed: Oct. 6, 2005
(86) PCT No.: PCT/JP05/18539

§ 371 Date: Mar. 30, 2009

(30) Foreign Application Priority Data
Oct. 6, 2004 (JP) 2004-294105

(51) Int. Cl. B32B 3/26; B29C 44/06

(52) U.S. Cl. 428/159; 264/45.6

(57) ABSTRACT

Disclosed is a resin molded article characterized by comprising a resin base as a hard foamed body composed of a thermosetting resin, a resin film composed of a thermoplastic resin, and a skin layer formed therebetween, wherein the skin layer is composed of the same thermosetting resin as that of the resin base and has a density larger than that of the resin base. Consequently, the strength of the surface of a resin base acting as an interface with a superficial layer of the resin molded article or the strength of a portion including the surface is increased, thereby suppressing deformation of the surface of the molded article and improving moldability as a resin molded article.

### TECHNICAL FIELD

The present invention relates to a resin molded article having a resin base as a hard foamed body composed of a thermosetting resin, a resin film composed of a thermoplastic resin, and a skin layer formed therebetween and a method of manufacturing the resin molded article.

### BACKGROUND ART

In general, interior parts such as an instrument panel and a steering wheel are installed in an automobile compartment. Further, a bumper and the like are attached as exterior parts. It is known that a resin molded article obtained by molding a resin, for example, polyurethane to a desired shape is used for these automobile interior and exterior parts.

When, for example, the resin molded article is manufactured, isocyanate as a raw material and polyol containing a foaming agent are charged into and mixed in a mixing chamber at predetermined pressure, respectively by reaction injection molding (RIM) and injected into hermetically sealed metal molds as soon as they are mixed. With this operation, a resin molded article composed of a reactive polyurethane resin and formed to a desired shape can be obtained.

An in-mold coating method disclosed in Patent Document 1 is known as an example of a method of forming a superficial layer on the surface of the resin molded article. In the method, when a resin is molded to a desired shape, a coating material (in-mold coating agent) is previously applied to the inner surface of metal molds to form a coated film, and a resin material is charged into the metal molds by injection molding. With this operation, a resin molded article having the coated film formed integrally with the surface of a resin base can be manufactured. Further, as another example, Patent Document 2 discloses a method of manufacturing a composite molded article (resin molded article) in such a manner that a surface skin obtained by thermally forming a thermoplastic resin sheet is previously formed on the inner surface of metal molds, a raw material for a core (resin material) is charged into the metal molds by injection molding, and the surface skin is directly integrated with the core.

Patent Document 1: Japanese Patent Application Laid-Open No. 7-329099

Patent Document 2: Japanese Patent Application Laid-Open No. 59-178236

### DISCLOSURE OF THE INVENTION

### Problems to be Solved by the Invention

However, when a resin base of a molded article is composed of a foamed body, the molded article is less strong due to bubbles existing on the surface of the resin base acting as an interface to a superficial layer composed of a coated film or a surface skin. Accordingly, as schematically shown in, for example, FIG. 4(b), when the surface of a resin molded article 11 having a thin superficial layer 13 formed on a foamed body 12 is depressed with a hard member, a problem arises in that the surface of the resin molded article 11 is easily deformed and a depressed trace remains. Further, although it is also possible to use a thick thermoplastic resin sheet (thickness: 2 to 4 mm) as a surface skin to solve the problem, it is difficult to form a corner and the like having a small bending radius when a thermoplastic resin sheet is thermally formed, from which a problem arises in moldability as a resin molded article.

An object of the present invention, which has been made in view of the above problems, is to provide a rein molded article capable of increasing the strength of the surface of a resin base acting as an interface with a superficial layer of the resin molded article or the strength of a portion including the surface and suppressing the deformation of the surface of the resin molded article as well as improving moldability as the resin molded article, and a method of manufacturing the resin molded article.

### Means for Solving the Problems

In order to achieve the above object, a resin molded article according to the present invention comprises a resin base as a hard foamed body composed of a thermosetting resin, a resin film composed of a thermoplastic resin, and a skin layer formed therebetween, being characterized in that the skin layer is composed of the same thermosetting resin as that of the resin base and has a density of at least 0.9 g/cc which is larger than that of the resin base.

In the resin molded article of the invention, it is preferable that the skin layer is created between the resin base and the resin film when the resin base is foam-molded, and bonded to the resin film integrally therewith.

Further, the resin film is preferably composed of at least one kind of vinyl chloride, polymethyl methacrylate, polycarbonate, polyethylene, polypropylene, polystyrene, ABS resin, AES resin, ASA resin, polyurethane, and nylon.

Preferably, the skin layer has a thickness of 0.2 mm or more and 1 mm or less. Further, the thermosetting resin is preferably polyurethane or nylon. In the invention, the hard foamed body acting as the resin base has a bending elastic modulus of 400 MPa or more and a bending strength of 15 MPa or more.

Further, in order to manufacture the resin molded article of the invention, a method of manufacturing a resin molded article comprising a resin base as a hard foamed body composed of a thermosetting resin, a resin film composed of a thermoplastic resin, and a skin layer formed therebetween, comprises: a clamping step of clamping metal molds after at least the resin film is attached in the metal molds used to foam-mold the resin base; and a step of setting the temperature of the metal molds on the sides thereof in direct contact with the resin film lower than that of a thermosetting resin material charged into the metal molds, charging the thermosetting resin material of the resin base previously added with a volatile organic solvent into the metal molds and foaming it, and molding the resin base to the resin film integrally therewith through a skin layer created when the thermosetting resin material is foamed.

In the method of manufacturing a resin molded article of the invention, the resin film is preferably composed of at least one kind of vinyl chloride, polymethyl methacrylate, polycarbonate, polyethylene, polypropylene, polystyrene, ABS resin, AES resin, ASA resin, polyurethane, and nylon.

It is preferable that the thermosetting resin comprises polyurethane or nylon, and it is also preferable that the volatile organic solvent preferably comprises any of pentane, methylene chloride, trichlene, and chlorofluorocarbon alternative.

Moreover, in the method of manufacturing a resin molded article of the invention, it is preferable that when the thermosetting resin is foamed, the temperature of the metal molds on the sides thereof in direct contact the resin film is set 5° C. or more and 10° C. or less lower than that of the charged thermosetting resin material in order to create the skin layer between the resin base and the resin film at a predetermined thickness as described above.

### ADVANTAGES OF THE INVENTION

As described above, the resin molded article of the present invention includes a resin base as a hard foamed body composed of a thermosetting resin, a resin film composed of a thermoplastic resin, and a skin layer formed therebetween, wherein the skin layer is composed of the same thermosetting resin as that of the resin base and has a density of at least 0.9 g/cc which is larger than that of the resin base. With this arrangement, since the skin layer has strength larger than that of the resin base, it can suppress deformation of the surface of the resin molded article. Further, since the resin film can be used due to the effect of the skin layer, moldability as the resin molded article can be improved.

The method of manufacturing a resin molded article according to the present invention includes a clamping step clamping metal molds after at least a resin film is attached in the metal molds, and a step of setting the temperature of the metal molds on the sides thereof in direct contact with the resin film lower than that of a thermosetting resin material charged into the metal molds, charging the thermosetting resin material of the resin base previously added with a volatile organic solvent into the metal molds and foaming it, and molding the resin base to the resin film integrally therewith through a skin layer created when the thermosetting resin material is foamed. As a result, the skin layer is created between the resin base and the resin film, a skin layer is further formed also on the surface of the resin base in direct contact with the metal mold when necessary, thereby it is possible to manufacture the resin molded article of the present invention having a three- or four-layer structure.

### BRIEF DESCRIPTION OF THE DRAWINGS

FIG. 1 is a schematic view schematically showing an arrangement of a resin molded article of the present invention.

FIG. 2 is an explanatory view schematically explaining a method of manufacturing the resin molded article of the present invention.

FIG. 3 is a graph showing the relation between the temperature difference between the temperature of a thermosetting resin when it is foam-molded and the temperature of a metal mold on the side thereof in direct contact with a resin film and the thickness of a skin layer created.

FIG. 4(a) is a view showing a state of the surface of the resin molded article of the invention when the surface thereof is depressed with a hard member, and FIG. 4(b) is a view showing a state of the surface of a conventional molded article when the surface thereof is depressed with the hard member.

### EXPLANATION OF REFERENCE NUMERALS

1 resin molded article
2 resin base
3 resin film
4 skin layer
5 metal molds
6 inlet port
11 conventional molded article
12 foamed body
13 superficial layer

### BEST MODE FOR CARRYING OUT THE INVENTION

A preferable embodiment of the present invention will be explained below.

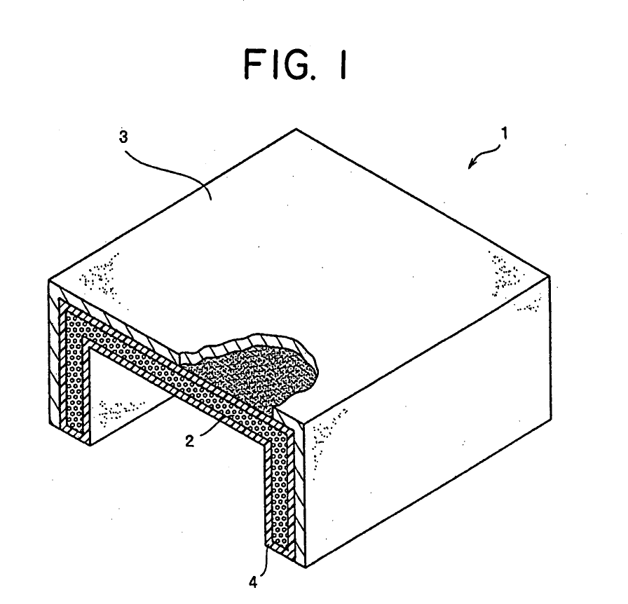

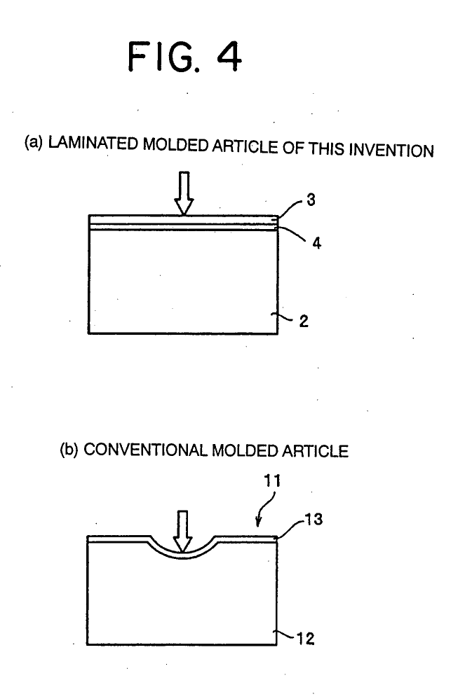

First, a resin molded article according to the embodiment of the present invention will be explained in detail with reference to FIGS. 1 and 4. FIG. 1 is a schematic view schematically showing an arrangement of the resin molded article according to the embodiment of the invention. FIG. 4 (a) shows a state of the resin molded article according to the embodiment of the invention when the surface thereof is depressed with a hard member, and FIG. 4(b) shows a state of a conventional resin molded article when the surface thereof is depressed with the hard member.

As shown in FIG. 1, the resin molded article 1 according to the embodiment of the invention has a four-layer structure arranged such that a skin layer 4 is formed between a resin base 2 as a hard foamed body composed of a thermosetting resin and a resin film 3 composed of a thermoplastic resin, and a skin layer 4 is further formed on the surface of the resin base 2.

In the resin molded article 1 arranged as described above, the resin film 3 is preferably composed of at least one kind of vinyl chloride, polymethyl methacrylate (PMMA), polycarbonate, polyethylene, polypropylene, polystyrene, ABS resin, AES resin, ASA resin, polyurethane, and nylon. In particular, when the resin film 3 is composed of AES resin, the resin molded article 1 can be provided with excellent whether resistance, and thus can be preferably applied to exterior parts used for an automobile, an outside wall of a building, and the like. Further, when the resin film 3 is a two-layer film composed of AES resin or ABS resin having about 0.2 mm thick PMMA formed on the AES resin or the ABS resin or a two-layer film composed of PMMA/ABS resins, the resin molded article 1 can be provided with an excellent gloss (degree of gloss is at least 80 on the surface of the molded article).

Further, when the resin film 3 contains pigment and/or metal powder, it acts as a decorative film and can provide the resin molded article 1 with an excellent decorative effect by concealing the resin base 2 and the skin layer 4. When, for example, the resin film 3 contains organic pigment and inorganic pigment, the surface of the resin molded article 1 can be provided with various colors by coloring the resin film 3. Further, it is also possible to increase the strength, durability, and corrosion resistance of the resin film 3. In addition, when the resin film 3 contains metal powder, the surface of the resin molded article 1 can be provided with a bright metallic gloss and luxuriousness.

When the resin base 2 is foam-molded, the skin layer 4 is created between the resin base 2 and the resin film 3 and bonded to the resin film 3 integrally therewith. Since the skin layer 4 is bonded to the resin film 3 integrally therewith, the skin layer 4 is firmly joined to the resin film 3, thereby the skin layer 4 can be prevented from being exfoliated from the resin film 3.

As will be explained below in detail, the skin layer 4 can be formed between the resin base 2 and the resin film 3 in such a manner that when a thermosetting resin material as a raw material of the resin base 2 is charged into metal molds, a volatile organic material such as pentane is previously added to the thermosetting resin material as well as when a thermosetting resin is foamed in a cavity of the metal molds, the temperature of the metal mold on the side thereof in contact with the resin film 3 is set lower than that of the thermosetting resin. It is difficult for a conventional art to create the skin layer 4, which has a predetermined wall thickness and a density of at least 0.9 g/cc which is higher than that of the resin base 2, between the resin base 2 and the resin film 3. It is possible to manufacture a resin molded article having the three-layer structure composed of the resin base 2, the skin layer 4, and the resin film 3 or the resin molded article 1 having the skin layer 4 further formed on the surface of the resin base 2 by the present invention for the first time.

The resin molded article 1 of the present invention has the skin layer 4 between the resin base 2 and the resin film 3. Consequently, even if a steel ball of 60 mmφ is dropped onto the resin molded article 1 from a position 50 cm above the surface thereof, the resin film 3 can suppress the resin molded article 1 from being deformed and prevent a trace of change from remaining on the surface of the molded article different from a conventional molded article. That is, the conventional molded article has the following problem. When the steel ball of 60 mmφ is dropped onto the molded article 11 having the foamed body 12 on which the superficial layer 13 composed of the coated film or the surface skin is formed from a position 50 cm above the surface thereof as described above, the molded article 11 is easily deformed due to the soft foamed body 12 existing just under the superficial layer 13 and a trace of a 23 mmφ recess remains (refer to FIG. 4(b)). However, in the resin molded article 1 of the embodiment, the above problem can be overcome by the existence of the skin layer 4.

Further, in the embodiment, the resin base 2 is molded by being foamed and cured by reacting a thermosetting resin material charged into the metal molds when it is foam-molded. Thus, the resin base 2 may be any hard foamed body as long as it has a bending elastic modulus of 400 MPa or more and a bending strength of 15 MPa or more. In particular, it is preferable that the resin base 2 be composed of a thermosetting resin such as polyurethane or nylon. When the resin base 2 is composed of polyurethane or nylon, the weight of the resin molded article 1 can be easily reduced. In particular, polyurethane can increase the field of application of the resin molded article 1 to the interior and exterior parts of an automobile, furniture, architectural materials, a food warmer, a refrigerator, and the like.

When, for example, the resin base 2 is composed of a hard polyurethane foamed body and the resin film 3 acts as a coated film decorated with a grain pattern and a woody texture due to pigment and metal powder contained therein, the resin molded article 1 can be used as interior parts of a driver's seat, an instrument panel, and the like of an automobile. When the resin base 2 is composed of a polyurethane foamed body and the resin film 3 acts as a coated film having corrosion resistance and whether resistance, the resin molded article 1 can be used as exterior parts such as a bumper of the automobile. In addition to the above mentioned applications, when the resin base 2 is composed of a polyurethane foamed body and the resin film 3 acts as a metallic coated film or a colored film, the resin molded article 1 can be applied to a food warmer, a refrigerator, and the like. Further, when the resin film 3 acts as a woody-coated film or a decorative panel, the resin molded article 1 can be also applied to furniture, architectural materials, and the like.

Note that, in the resin molded article 1 according to the embodiment, the size and shape of the resin molded article 1 or the wall thicknesses of the resin film 3 and the skin layer 4 are not particularly limited and may be arbitrarily selected according to the application and the like of the resin molded article 1. Although the resin molded article 1 shown in FIG. 1 has, for example, a C-shape, it is possible to provide it with reinforcing ribs or bosses projecting therefrom so that the resin molded article 1 can be assembled with other part, and further the resin molded article 1 may be formed to various shapes in addition to the above shape. In this case, the resin film 3 bonded to the skin layer 4 integrally therewith is thermally formed to a desired shape before it is molded integrally with the resin base 2 through the skin layer 4. In addition, since the thermosetting resin is foam-molded using very accurately designed metal molds, the resin base 2 can be foam-molded to a desired shape.

Further, in the resin molded article 1, the skin layer 4 formed between the resin base 2 and the resin film 3 preferably has a wall thickness of 0.2 mm or more. When the skin layer 4 harder than the resin base 2 has the wall thickness of 0.2 mm or more as described above, it can prevent a trace of change as described above from remaining on the surface of the molded article. Further, occurrence of exfoliation in the interface between the skin layer 4 and the resin film 3 can be more prevented. In contrast, when the skin layer 4 is formed excessively thick, brittleness appears as the hardness of the skin layer 4 increases, and it is therefore preferable that the wall thickness of the skin layer 4 be set to 1 mm or less.

Further, when the resin base 2 contains carbon black and the resin film 3 is a coated film of pale color such as yellow or white, it is preferable to set the wall thickness of the resin film 3 to at least 0.4 mm and in particular to at least 0.45 mm such that the resin film 3 has a sufficient concealing ability although the wall thickness varies depending on, for example, the type and the amount of the pigment and the metal powder contained in the resin film 3. Further, when the resin film 3 is a coated film of a deep color such as black gray and dark blue, it is preferable to set the wall thickness thereof to at least 0.25 mm and in particular to at least 0.3 mm. Note that the wall thickness of the resin film 3 is preferably set to 1 mm or less since a cost is increased and reduction in weight of the resin molded article 1 is prevented when the resin film 3 is excessively thick.

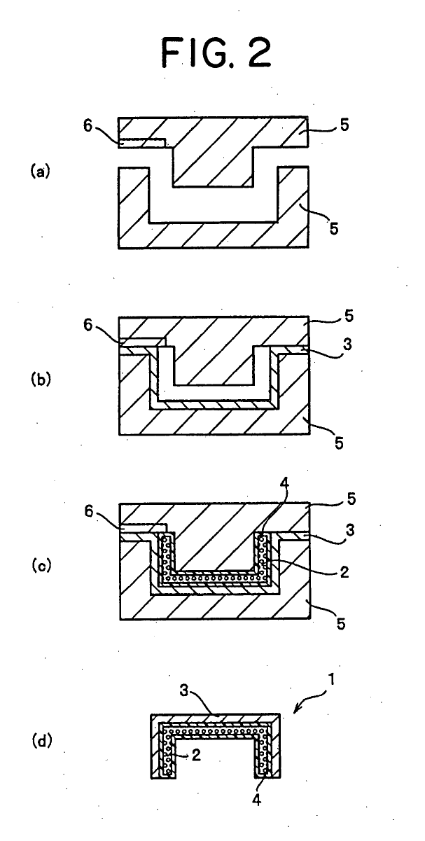

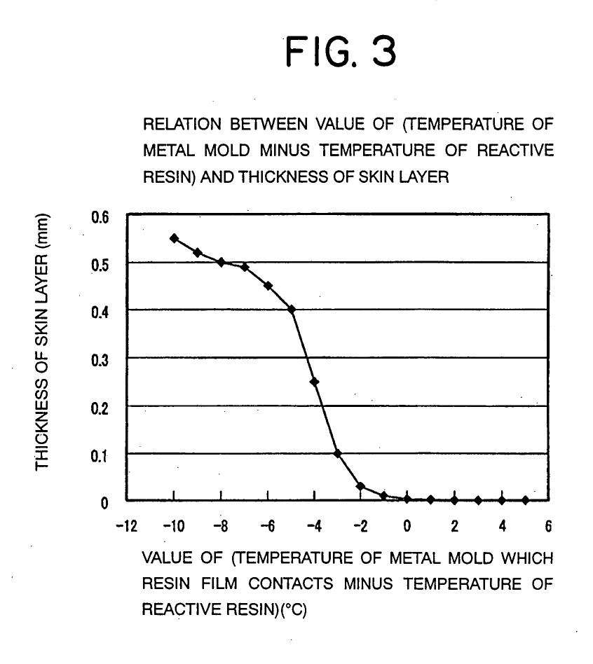

Next, a method of manufacturing the resin molded article 1 according to the embodiment of the invention described above will be explained with reference to FIGS. 2 and 3. FIG. 2 is an explanatory view schematically explaining the method of manufacturing the resin molded article 1 according to the embodiment of the invention. FIG. 3 is a graph showing the relation between the temperature difference between the temperature of a thermosetting resin when it is foam-molded and the temperature of the metal mold on the side thereof in direct contact with the resin film and the thickness of the skin layer created.

First, as shown in FIG. 2(a), the metal molds 5 for foam-molding the resin base 2 are prepared. At the time, metal molds similar to those used conventionally can be used as the metal molds 5, and it is assumed that the metal molds 5 are designed with a pinpoint accuracy such that the resin molded article 1 having a desired shape can be manufactured. Further, an inlet port 6 for charging the thermosetting resin material is formed by forming a groove to a part of the surface through which the upper and lower metal molds 5 are abutted against each other such that the resin molded article 1 can be easily taken out from the metal molds 5 after it is foam-molded. Here, the groove for the inlet port 6 is formed to the upper metal mold 5 to charge the thermosetting resin material into a space (cavity) formed by the resin film 3 and the upper metal mold 5.

Next, the resin film 3 is manufactured to a predetermined thickness. Before the resultant resin film 3 is attached to the metal molds 5, it is previously subjected to thermal forming such as vacuum forming and pressure forming such that it is created to a desired shape. Methods of manufacturing and thermally forming the resin film 3 are not particularly limited, and methods similar to conventional ones can be used. Note that, when it is not necessary to thermally form the resin film 3 at the time a sheet-shaped article, for example, is manufactured as the resin molded article 1, the thermally forming process of the resin film 3 can be omitted.

At the time, although it is sufficient that the resin film 3 to be manufactured be composed of a thermoplastic resin, it is preferably composed of at least one kind of vinyl chloride, PMMA, polycarbonate, polyethylene, polypropylene, polystyrene, ABS resin, AES resin, ASA resin, polyurethane, and nylon as described above. Further, when the resin film is manufactured, pigment and/or metal powder may be contained in the resin film 3. When the resin molded article 1 is manufactured, the resin film 3 acts as the coated film as described above by containing the pigment and the metal powder, thereby it is possible to provide the resin molded article 1 with an excellent decorative effect.

As shown in FIG. 2(b), the thermally formed resin film 3 is attached to the metal molds 5 prepared as described above, and the metal molds 5 are clamped by a clamping mechanism. When the resin film 3 is attached to the metal molds 5, a suction mechanism may be disposed to the metal molds 5 on the sides thereof in contact with the resin film 3 to increase the intimate contact property of the resin film 3 to the metal mold 5. For example, a single or a plurality of through holes is/are formed to the metal mold 5 therethrough from the outside to the surface thereof in contact with the resin film 3 as necessary, and a suction pump is connected to the opening of the holes outside of the metal mold 5, thereby the intimate contact property between the resin film 3 and the metal mold 5 can be increased by sucking air in the holes.

After the clamping process is carried out, a thermosetting resin material, to which a volatile organic solvent is previously added and which is used as a raw material of the resin base 2, is charged into the clamped metal molds 5. At the time, a method of charging a thermosetting resin material may be variously selected depending on the property and the like of the resin material. When, for example, the thermosetting resin material has a low viscosity, it can be flown and charged into the cavity of the metal molds 5 at a low pressure. In contrast, when the thermosetting resin material has a relatively high viscosity, it can be injected into the cavity of the metal molds 5 at a high pressure. Further, when the thermosetting resin is composed of, for example, polyurethane or nylon as described above, the thermosetting resin material added with the volatile organic solvent can be injected into the metal molds 5 by reaction injection molding (RIM).

A case in which polyurethane is foam-molded by the reaction injection molding will be more specifically explained here. First, thermosetting resin materials of isocyanate and polyol containing a foaming agent, which are accommodated in different raw material tanks, are charged into a mixing chamber disposed just in front of the metal molds 5 in predetermined amounts, respectively and mixed with each other therein as well as a predetermined amount of a volatile organic solvent is added thereto. When the thermosetting resin materials are charged into the metal molds 5 at a low pressure, a mechanism for rotating a stirring blade by an electrically driven motor, for example, is disposed in the mixing chamber, and the thermosetting resin materials are mixed while being stirred. Whereas when the thermosetting resin materials are charged at a high pressure, the stirring mechanism is not necessary, and they are mixed by collision. Thereafter, the mixed thermosetting resin materials are injected into the cavity of the clamped metal molds 5 from the mixing chamber. At the time, it is also possible to charge polyol previously mixed with water as a foaming agent into the mixing chamber. Further, when necessary, a catalyst, a curing agent, a foaming agent, and the like may be added to the thermosetting resin material charged into the metal molds.

In this case, examples of the isocyanate as one of the thermosetting resin material include tolylene diisocyanate, diphenyl methane diisocyanate, and hexane methylene diisocyanate. Further, examples of the polyol include polyether polyol, polyester polyol, polycarbonate polyol, polyolefin polyol, and acryl polyol.

Further, in the embodiment, a volatile organic solvent composed of any one of pentane, methylene chloride, trichlene, ozone-safe type chlorofluorocarbon alternative (for example, HFC, HCFC, and the like) may be used as the volatile organic solvent to be added to the thermosetting resin material. As a result, when the thermosetting resin materials are foamed in the cavity of the metal molds 5, the skin layer 4 can be securely formed between the resin base 2 as the hard foamed body and the resin film 3 composed of the thermoplastic resin.

Further in this case, a foaming ratio at which the thermosetting resin materials are foamed can be controlled by changing the amount of the volatile organic solvent to be added. When, for example, the foaming ratio of the thermosetting resin material is excessively large when it is foam-molded, the structure of a foamed body may be coarsened and its strength may be reduced when the resin molded article 1 is manufactured, or buckling may be liable to occur when the resin molded article 1 is bent. In contrast, when the foaming ratio is excessively small inversely, it is contemplated that the resin base cannot be accurately formed to a desired shape because a sink mark occurs when the thermosetting resin is foam-molded. Accordingly, it is preferable to adjust the additive amount of the volatile organic solvent to a predetermined amount to the thermosetting resin materials. When, for example, the volatile organic solvent is pentane, it is preferable to adjust the additive amount to 3 to 24 wt % to polyol. In particular, to securely prevent occurrence of buckling in the resin molded article 1, it is more preferable to adjust the additive amount of pentane to 4 to 7 wt % and, if possible, to about 5 wt % to polyol. Further, when the volatile organic solvent is methylene chloride, it is preferable to adjust the additive amount thereof to 5 to 7 wt % to polyol. When the volatile organic solvent is trichlene, it is preferable to adjust the additive amount thereof to 8 to 12 wt %. When the volatile organic solvent is chlorofluorocarbon alternative, it is preferable to adjust the additive amount thereof to 2 to 15 wt % and in particular to 5 wt %.

The temperature of the metal mold on the side thereof in direct contact with the resin film 3 is set lower than that of the charged thermosetting resin material, the thermosetting resin materials to which the volatile organic solvent is added are charged from the mixing chamber described above into the metal molds 5 through the inlet port 6, and the thermosetting resin materials are reacted in the cavity of the metal molds 5 thereby to perform a process for foaming the thermosetting resin materials at a low pressure and molding the resin base 2 integrally with the resin film 3 through the skin layer 4 created when the resin materials are foamed (FIG. 2(c)).

In the process, when the thermosetting resin materials charged into the metal molds 5 are foamed and cured, the temperature of the metal molds 5 on the sides thereof in direct contact with the resin film 3 is set lower than the temperature of the thermosetting resin materials. Accordingly, foaming of the thermosetting resin materials is suppressed by delaying the reaction thereof in the portion thereof in contact with the resin film 3 and in the vicinity of the resin film 3. In addition, the foaming is further suppressed by applying the pressure of the gas generated by the volatile organic solvent and the pressure of a foaming gas to the portion of the thermosetting resin materials in contact with the resin film 3 whose reaction is delayed and to the vicinity thereof. As a consequence, the skin layer 4, which is more dense than the resin base 2 as well as very hard, can be created. When the thermosetting resin is composed of, for example, polyurethane, the resin has a temperature of about 20 to 50° C., and thus, the temperature of the metal molds 5 on the sides thereof in direct contact with the resin film 3 is set to a temperature lower than the temperature of the resin. When the temperature of the metal mold 5 is set lower than the temperature of the resin as described above, the resin base 2 can be molded by that the thermosetting resin materials are foamed and cured in a short time. At the same time, the skin layer 4 can be created between the cured resin base 2 and the resin film 3, and further the resin base 2 can be bonded to the resin film 3 integrally therewith through the skin layer 4 making use of the bonding property of the thus created skin layer 4 composed of polyurethane.

Further, when thermosetting resins are foamed, as the temperature of the metal molds 5 on the sides thereof in direct contact with the resin film 3 is made lower than that of the thermosetting resin materials, the skin layer 4 created between the resin base 2 and the resin film 3 can be made thicker as shown in, for example, FIG. 3. That is, the thickness of the skin layer created to the resin molded article can be adjusted by adjusting the difference between the temperature of the metal mold and that of the thermosetting resins. Accordingly, when the temperature of the metal molds 5 on the sides thereof in direct contact with the resin film 3 is set 5° C. or more lower than that of the thermosetting resin materials, it is possible to easily create the skin layer 4 in a preferable wall thickness of 0.2 mm or more and 1 mm or less. In particular, when the temperature of the metal molds is set lower than that of the thermosetting resin materials within the range of 3° C. or more and 10° C. or less, and more preferably within the range of 5° C. or more and 10° C. or less, the skin layer 4 can be stably created in a wall thickness of 0.4 mm or more and 0.55 mm or less.

Further, when the foaming ratio of the thermosetting resin materials is reduced and the density ρ of the portion composed of the resin base 2 and the skin layer 4 is increased, the wall thickness of the skin layer 4 can be increased. When the density is increased up to, for example, ρ=0.5 to 0.6 (about twice in terms of a foaming ratio), the wall thickness of the skin layer 4 can be increased. However, when the density exceeds ρ=0.6, the skin layer 4 is made thick as well as a cost is increased. For this reason, it is preferable to suppress the density ρ to 0.6 or less.

Further, in the embodiment, when, for example, polyurethane is foam-molded by the reaction injection molding as described above, a thermosetting resin can be foamed at a low pressure. Accordingly, molds made of resin, for example, can be also used in addition to metal molds generally used conventionally as molds for foam-molding resin. Furthermore, in the embodiment, it is possible to form a skin layer 4 in a predetermined thickness also to the surface of the resin base 2 on the side thereof in which the resin film 3 is not disposed by setting the temperature of the metal mold 5 on the side thereof in which the resin film 3 is not attached lower than that of the thermosetting resin materials.

After thermosetting resins are perfectly foamed, the resin molded article 1 as shown in FIG. 2(d) can be manufactured by taking out the resin molded article 1, which has the three-layered structure composed of the resin base 2, the skin layer 4, and the resin film 3, from the metal molds 5 and cutting off unnecessary portions such as the thermosetting resins cured in the outer periphery of the resin film 3 and in the inlet port 6, and the like.

Note that the embodiment of the present invention is explained above while exemplifying the example that the thermosetting resin that mainly constitutes the resin base 2 is composed of polyurethane. However, the present invention is by no means limited thereto and can be also applied to a case in which the thermosetting resin is composed of nylon and a case in which it is a hard foamed body composed to other thermosetting resin.

In the case where the thermosetting resin is composed of, for example, nylon, the resin molded article 1 is manufactured in such a manner that when the thermosetting resin material is charged into the metal molds 5 to which the resin film 3 is attached, ε-caprolactam as the resin material, a polymerization catalyst such as potassium, and a polymerization initiator such as N-acetyl-ε-caprolactam are mixed with each other and charged into the metal molds 5 after they are added with a volatile organic solvent and a foaming agent. The steps other than the above step are carried out likewise the case of polyurethane.

### Examples

A resin molded article 1 having a skin layer 4 between a resin base 2 composed of hard polyurethane and a resin film 3 composed of AES resin was manufactured as an example as described below by a manufacturing method according to the embodiment of the present invention as shown in FIG. 2, and the resultant resin molded article 1 was subjected to a weather resistance test, a cold resistance test, and a freezing test.

First, the resin film 3 composed of the AES resin colored by inorganic pigment contained therein was manufactured to a thickness of about 0.6 mm and thermally formed in conformity with the shape of the metal molds 5. Subsequently, the thermally formed resin film 3 was attached to the metal molds 5, and the metal molds 5 were clamped by the clamping mechanism.

Next, ether polyol added with 5 wt % of pentane as a volatile organic solvent was mixed with water as a foaming agent, and they were injected into the cavity of the clamped metal molds 5 after they were added with tolylene diisocyanate. The thermosetting resin material was formed and cured at about 30° C., to manufacture the resin molded article 1 in which the resin base 2 is molded to the resin film 3 integrally therewith through the skin layer 4. Note that when the thermosetting resin was foam-molded, the temperature of the metal molds 5 on the sides thereof in contact with the resin film 3 was set to about 25° C.

When the average density of a polyurethane foamed body in the resultant resin molded article 1 was examined, it was confirmed that the average density was about 0.28 g/cc.

### (Weather Resistance Test)

Thereafter, the thus manufactured resin molded article 1 was subjected to an accelerated exposure test for exposing the surface of the resin film 3 of the resin molded article 1 to energy up to 125 MJ/m² (exposing energy for about 10 years) using an accelerated weather resistance tester having a discharge lamp filled with xenon gas as a light source (xenon lamp). Then, the whether resistance of the resin molded article 1 subjected to the accelerated exposure test was evaluated by measuring the color difference ΔE of the surface of the resin film 3 subjected to the accelerated exposure test.

First, the color difference ΔE of the surface of the resin film 3 subjected to the accelerated exposure test was measured by a colorimeter using the surface of the resin film 3 before it was subjected to the weather resistance test as a reference. As a result, since the color difference showed ΔE=2.84 which was less than ΔE=5 in which almost no color deterioration was admitted, it was confirmed that resistance against color deterioration was satisfied. Further, when the resin film was subjected to a forcible exfoliation test using a test piece after it was exposed, no exfoliation occurred in the interface between the skin layer and the resin film and in the interface between the skin layer and an internal foamed structure.

### (Cold Resistance Test)

After the thus manufactured resin molded article 1 was kept in an atmosphere of −60±2° C. for five hours, the surface of the resin film 3 of the resin molded article 1 and the interface between the resin film 3 and the skin layer 4 were observed. As a result, defects of the surface of the resin film 3 such as bubbles, bulges, cracks, and the like and exfoliation of the resin film 3 were not admitted at all, and further neither discoloration nor a change of glossiness of the resin film 3 was also admitted.

### (Freezing Test)

After the thus manufactured resin molded article 1 was dipped in water for 24 hours, it was frozen in an atmosphere of −30° C. for one hour, and then the surface of the resin film 3 of the resin molded article 1 and the interface between the resin film 3 and the skin layer 4 were observed. As a result, defects of the surface of the resin film 3 such as bubbles, bulges, cracks, and the like and exfoliation of the resin film 3 were not admitted at all and further neither discoloration nor a change of glossiness of the resin film 3 was also admitted. In addition, when the resin film was subjected to a forcible exfoliation test using a test piece after it was tested, no exfoliation occurred in the interface between the skin layer and the resin film and in the interface between the skin layer and an internal foamed structure.

It was confirmed from the results of the weather resistance test, the cold resistance test, and the freezing test that the resin molded article 1 of the present invention was sufficiently excellent in weather resistance and environment resistance. Further, no exfoliation occurred in the interface between the skin layer and the resin film and the interface between the skin layer and the internal foamed structure.

### INDUSTRIAL APPLICABILITY

The resin molded article of the present invention can be applied to interior and exterior parts of a construction machine and an automobile, a food warmer, a refrigerator, furniture, architectural materials, and the like.

1. A resin molded article characterized by comprising a resin base as a hard foamed body composed of a thermosetting resin, a resin film composed of a thermoplastic resin, and a skin layer formed therebetween,
wherein the skin layer is composed of the same thermosetting resin as that of the resin base and has a density of at least 0.9 g/cc which is larger than that of the resin base.

2. The resin molded article according to claim 1, wherein the skin layer is created between the resin base and the resin film when the resin base is foam-molded, and bonded to the resin film integrally therewith.

3. The resin molded article according to claim 1, wherein the resin film is composed of at least one kind of vinyl chloride, polymethyl methacrylate, polycarbonate, polyethylene, polypropylene, polystyrene, ABS resin, AES resin, ASA resin, polyurethane, and nylon.

4. The resin molded article according to claim 1, wherein the skin layer has a thickness of 0.2 mm or more and 1 mm or less.

5. The resin molded article according to claim 1, wherein the thermosetting resin is polyurethane or nylon.

6. The resin molded article according to claim 1, wherein the hard foamed body acting as the resin base has a bending elastic modulus of 400 MPa or more and a bending strength of 15 MPa or more.

7. A method of manufacturing a resin molded article comprising a resin base as a hard foamed body composed of a thermosetting resin, a resin film composed of a thermoplastic resin, and a skin layer formed therebetween, the method comprising:
a clamping step of clamping metal molds after the resin film is attached in the metal molds used to foam-mold the resin base; and
a step of setting a temperature of the metal molds on the sides thereof in direct contact with the resin film lower than that of a thermosetting resin material charged into the metal molds, charging the thermosetting resin material of the resin base previously added with a volatile organic solvent into the metal molds and foaming it, and molding the resin base to the resin film integrally therewith through the skin layer created when the thermosetting resin material is foamed.

8. The method of manufacturing a resin molded article according to claim 7, wherein the resin film is composed of at least one kind of vinyl chloride, polymethyl methacrylate, polycarbonate, polyethylene, polypropylene, polystyrene, ABS resin, AES resin, ASA resin, polyurethane, and nylon.

9. The method of manufacturing a resin molded article according to claim 7, wherein the thermosetting resin comprises polyurethane or nylon.

10. The method of manufacturing a resin molded article according to claim 7, wherein the volatile organic solvent comprises any of pentane, methylene chloride, trichlene, and chlorofluorocarbon alternative.

11. The method of manufacturing a resin molded article according to claim 7, wherein when the thermosetting resin is foamed, the temperature of the metal molds on the sides thereof in direct contact the resin film is set 5° C. or more and 10° C. or less lower than that of the charged thermosetting resin material.
